(19) United States
(12) Patent Application Publication
(10) Pub. No.: US 2022/0345688 A1
(43) Pub. Date: Oct. 27, 2022

(54) VEHICLE MONITORING SYSTEM AND MALFUNCTION MONITORING METHOD

(71) Applicant: Panasonic Intellectual Property Management Co., Ltd., Osaka (JP)

(72) Inventors: Takuma INUI, Osaka (JP); Tomohiro KOGANEI, Osaka (JP); Kenji MATSUOKA, Osaka (JP); Daisuke YOKOHAGI, Osaka (JP); Daiki OKUMURA, Osaka (JP)

(73) Assignee: Panasonic Intellectual Property Management Co., Ltd., Osaka (JP)

(21) Appl. No.: 17/725,016

(22) Filed: Apr. 20, 2022

(30) Foreign Application Priority Data
Apr. 26, 2021 (JP) 2021-073897

(51) Int. Cl. H04N 17/00; B60W 60/00

(52) U.S. Cl. CPC H04N 17/002; B60W 60/001; B60W 2556/45

(57) ABSTRACT

A vehicle monitoring system includes: a monitoring device that monitors whether a person is present or not in a cabin of a vehicle capable of autonomous driving; and a control device that determines whether the monitoring device is experiencing a malfunction, and outputs a result of the determination.

### CROSS REFERENCE TO RELATED APPLICATION

The present application is based on and claims priority of Japanese Patent Application No. 2021-073897 filed on Apr. 26, 2021.

### FIELD

The present disclosure relates to a vehicle monitoring system and a malfunction monitoring method.

### BACKGROUND

In recent years, automated valet parking systems that guide vehicles to park the vehicles in predetermined parking spaces in parking lots using an autonomous operation mode have been developed. Such automated valet parking systems are built on the precondition that no one is present in the parking lots. For this reason, presence of a person in the automated valet parking lots may hinder the operation of the automated valet parking systems.

Patent Literature (PTL) 1 discloses a monitoring system for monitoring vehicles in a parking lot using an autonomous operation mode. The monitoring system monitors vehicles in a parking lot to inspect whether one or more people are present in cabins of the vehicles, and eliminates people from the parking lot by performing one or more actions depending on the inspection.

### CITATION LIST

### Patent Literature

PTL 1: Japanese Patent No. 6490228

### SUMMARY

The above-described monitoring system according to PTL 1 can be improved upon.

The present disclosure is capable of further improving upon the above relate art.

A vehicle monitoring system according to one aspect of the present disclosure includes: a monitoring device that monitors whether a person is present or not in a cabin of a vehicle capable of autonomous driving; and a control device that determines whether the monitoring device is experiencing a malfunction, and outputs a result of the determination.

Note that these comprehensive or concrete embodiments may be implemented by a system, a method, an integrated circuit, a computer program, or a computer-readable storage medium such as a CD-ROM, or by optionally combining a system, a method, an integrated circuit, a computer program, or a storage medium.

The present disclosure is capable of further improving upon the above relate art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram schematically illustrating a vehicle management system according to an embodiment.

FIG. 2 is a block diagram illustrating the vehicle monitoring system according to the embodiment.

FIG. 3 is a flowchart illustrating operation performed by the vehicle monitoring system according to the embodiment.

FIG. 4 is a diagram schematically illustrating an action performed by the vehicle monitoring system, when a person is present in a parking lot.

### DESCRIPTION OF EMBODIMENTS

Hereinafter, embodiments according to the present disclosure will be described with reference to the drawings. The embodiments described below each show a particular example of the present disclosure. Numerical values, shapes, materials, structural elements, the arrangement and connection of the structural elements, etc. presented in the embodiments below are mere examples and do not limit the present disclosure. Therefore, among the structural elements in the following embodiments, structural elements not recited in any of the independent claims are described as optional structural elements.

Note that the drawings are schematic diagrams, and do not necessarily provide strictly accurate illustration. Throughout the drawings, the same reference numeral is given to the same structural element.

Hereinafter, embodiments are described in detail with reference to the drawings.

### Embodiment

### [Configuration: Vehicle Management System 1]

First, a configuration of vehicle management system 1 according to an embodiment will be described.

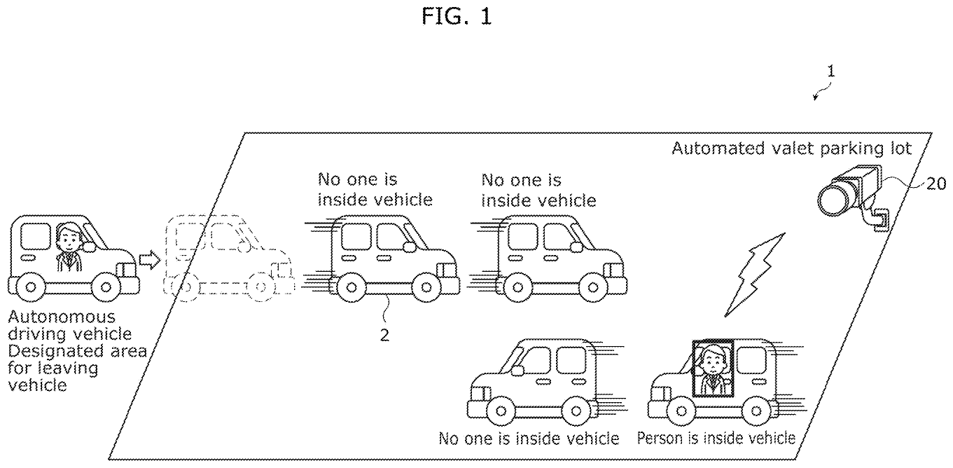

FIG. 1 is a diagram schematically illustrating vehicle management system 1 according to the embodiment.

As illustrated in FIG. 1, vehicle management system 1 according to the embodiment controls autonomous driving of vehicles 2 in an automated valet parking lot. Vehicle management system 1 causes vehicles 2 to autonomously drive from an entrance of the parking lot to predetermined parking spaces that are destinations in the parking lot, and causes vehicles 2 to be autonomously parked in the parking spaces. In order to cause vehicles 2 to leave the automated valet parking lot, vehicle management system 1 causes vehicles 2 parked in the parking spaces to autonomously drive to arrive at an exit of the parking lot.

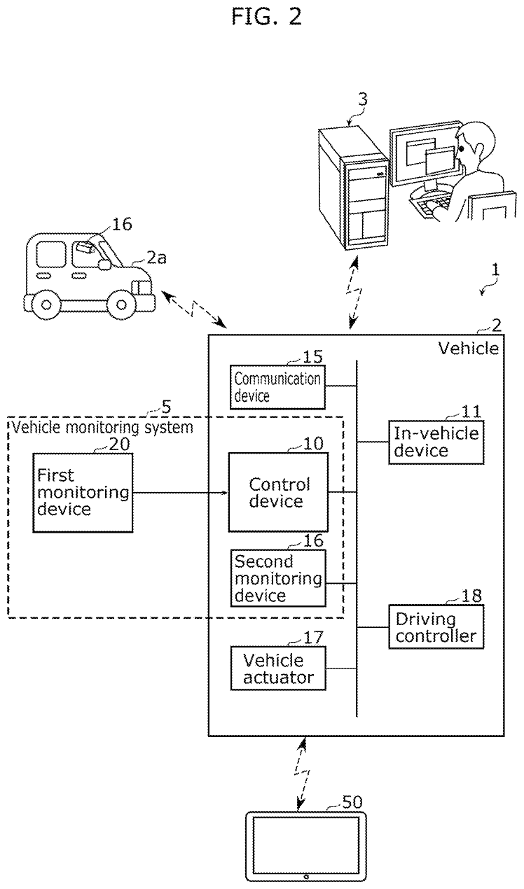

FIG. 2 is a block diagram illustrating vehicle monitoring system 5 according to the embodiment.

As illustrated in FIG. 2, vehicle management system 1 includes vehicle 2 and first monitoring device 20. In addition, vehicle management system 1 includes vehicle monitoring system 5. Vehicle monitoring system 5 includes first monitoring device 20 provided outside vehicle 2, second monitoring device 16 that vehicle 2 is provided with, and control device 10 that vehicle 2 is provided with. Although vehicle monitoring system 5 according to the embodiment includes first monitoring device 20 and second monitoring device 16, the embodiment is not limited to the foregoing. In other words, vehicle monitoring system 5 may only include first monitoring device 20 or second monitoring device 16.

The embodiment is described using an example in which a monitoring device is provided outside vehicle 2 and vehicle 2 is provided with a monitoring device; however, the embodiment is not limited to the foregoing. In other words, a monitoring device is to be provided at least outside vehicle 2, or at least vehicle 2 is provided with a monitoring device.

First monitoring device 20 is wirelessly, communicably connected with control device 10 using a communication module, etc. First monitoring device 20 includes, for example, a camera that captures an image of the site of the automated valet parking lot, a proximity sensor that detects the approach of vehicles 2, etc. One or several first monitoring devices 20 may be provided in the automated valet parking lot. First monitoring device 20 is one example of a monitoring device.

First monitoring device 20 can detect a malfunction in itself by detecting its own state at fixed intervals, using a state detector (not illustrated) etc. capable of detecting its own state. When first monitoring device 20 malfunctions, first monitoring device 20 outputs a first signal indicating that first monitoring device 20 itself is experiencing a malfunction. Specifically, when the state detector detects a malfunction in first monitoring device 20, first monitoring device 20 transmits the first signal to vehicles 2 in the automated valet parking lot. For example, first monitoring device 20 may transmit the first signal to each vehicle 2, irrespective of whether a person is present or not in the cabins. Moreover, when a person is present in a cabin, but vehicle 2 in which the person is present cannot be identified, first monitoring device 20 may transmit the first signal to every vehicle 2 in the automated valet parking lot.

In addition, first monitoring device 20 is provided outside vehicles 2, and monitors whether a person is present or not in cabins of vehicles 2 capable of autonomous driving. Specifically, when first monitoring device 20 detects a person in a cabin or a person outside a vehicle in the automated valet parking lot, first monitoring device 20 transmits, to vehicles 2, human detection information indicating the presence of a person in a cabin or outside a vehicle in the automated valet parking lot.

Vehicle 2 includes second monitoring device 16, control device 10, in-vehicle device 11, communication device 15, driving controller 18, and vehicle actuator 17.

Second monitoring device 16 is communicably connected with control device 10. Second monitoring device 16 includes, for example, an in-vehicle camera capable of capturing an image of a cabin or the vicinity of vehicle 2, a radar sensor, an ultrasonic sensor, etc. Vehicle 2 may be provided with one or several second monitoring devices 16. Second monitoring device 16 is one example of a monitoring device.

Second monitoring device 16 can also detect a malfunction in itself by detecting its own state at fixed intervals, using a state detector (not illustrated) etc. capable of detecting its own state. When second monitoring device 16 malfunctions, second monitoring device 16 outputs a second signal indicating that second monitoring device 16 itself is experiencing a malfunction. Specifically, when the state detector detects a malfunction in second monitoring device 16, second monitoring device 16 transmits the second signal to control device 10. For example, second monitoring device 16 may transmit the second signal to vehicle 2 provided with second monitoring device 16, irrespective of whether a person is present or not in the cabin. Moreover, when a person is present in the cabin, second monitoring device 16 may transmit the second signal to every vehicle 2 in the automated valet parking lot.

In addition, second monitoring device 16 is a device that vehicle 2 is provided with, and monitors whether a person is present or not in at least the cabin of vehicle 2. Specifically, second monitoring device 16 is provided in a cabin, and monitors whether a person is present or not in the cabin of vehicle 2. Moreover, second monitoring device 16 can also monitor whether a person is present or not in the vicinity of vehicle 2. Specifically, when second monitoring device 16 detects a person in the cabin or a person in the vicinity of vehicle 2, second monitoring device 16 transmits, to vehicle 2, human detection information indicating the presence of a person in a cabin or in the vicinity of vehicle 2 in the automated valet parking lot.

Control device 10 determines whether first monitoring device 20 is experiencing a malfunction, and outputs a result of the determination. Specifically, when control device 10 that vehicle 2 is provided with determines that first monitoring device 20 is experiencing a malfunction by receiving a first signal from first monitoring device 20, control device 10 provides a notification of first malfunction information that is information about the malfunction to vehicle 2. First malfunction information includes that first monitoring device 20 is experiencing a malfunction, and that a person present in a cabin needs to get out of the vehicle for evacuation. Here, the notification includes an output of voice by an acoustic device, display of text by a display device, display of an image by a display device, etc.

Moreover, control device 10 determines whether second monitoring device 16 is experiencing a malfunction, and outputs a result of the determination. Specifically, when control device 10 that vehicle 2 is provided with determines that second monitoring device 16 is experiencing a malfunction by receiving a second signal from second monitoring device 16, control device 10 provides a notification of second malfunction information that is information about the malfunction to vehicle 2. Second malfunction information includes that second monitoring device 16 is experiencing a malfunction, and that a person present in a cabin needs to get out of the vehicle for evacuation. The notification here is the same as the notification described above, and indicates that second monitoring device 16 is experiencing a malfunction. Note that control device 10 may provide the notification of second malfunction information to another vehicle 2a, which is different from vehicle 2 to which the second malfunction information has been notified, by transmitting the second malfunction information to another vehicle 2a.

Moreover, after control device 10 has provided a notification of malfunction information such as first malfunction information and/or second malfunction information, control device 10 causes vehicle 2 provided with control device 10, external device 3, terminal device 50, etc. to perform an action different from providing of the malfunction information notification. The action is predetermined, and includes the following actions, for example.

For example, as one of the actions, control device 10 controls a device present in vehicle 2 to actuate the device such that a person is intuitively become aware of the notification. A device present in vehicle 2 is, for example, in-vehicle device 11, such as an acoustic device, an in-vehicle lighting device, a display device, a seat device, terminal device 50 present in vehicle 2, etc. Here, the acoustic device is in-vehicle audio equipment, a speaker, a radio, etc. The in-vehicle lighting device is a headlight, a turn signal, an interior vehicle light, warning light, etc. The display device is car navigation equipment, an in-vehicle monitor, etc. The seat device is a vibration seat that vibrates an in-vehicle seat, a massage seat, etc. Terminal device 50 is a smartphone, a tablet terminal, etc. which is brought inside a vehicle or which the vehicle is provided with. As one of the actions, control device 10 provides a notification of malfunction information to terminal device 50 via communication device 15. Here, communication device 15 is a communication module that transmits second malfunction information to external device 3 and another vehicle 2a, and receives second malfunction information from another vehicle 2a.

Moreover, as one of the actions, control device 10 provides a notification of malfunction information to external device 3. External device 3 is a server that monitors and manages first monitoring device 20 and every vehicle 2 in the automated valet parking lot, for example. When first monitoring device 20 and/or second monitoring device 16 malfunction, control device 10 can provide a notification of malfunction information to external device 3 to notify a manager of external device 3 that first monitoring device 20 and/or second monitoring device 16 are experiencing a malfunction, and that a person present in a cabin needs to get out of the vehicle for evacuation.

In addition, as one of the actions, control device 10 turns the ignition switch OFF and stops vehicle 2. After vehicle 2 is stopped and the ignition switch is turned OFF, control device 10 automatically turns the ignition switch of vehicle 2 ON. Specifically, control device 10 causes vehicle 2 to restart, considering the possibility of a malfunction in vehicle 2.

Furthermore, as one of the actions, control device 10 controls vehicle 2 such that vehicle 2 is moved to a predetermined location. When control device 10 outputs an instruction to driving controller 18, driving controller 18 controls vehicle actuator 17 such that vehicle 2 is autonomously driven to pass through a predetermined location or stops at a predetermined location. With this, when a person is present in a vehicle, the person can get out of vehicle 2 that has stopped at a predetermined location, or an image of the cabin of vehicle 2 can be captured in detail by causing vehicle 2 to pass through a predetermined location where first monitoring device 20 can readily capture the image.

Here, driving controller 18 causes vehicle 2 to autonomously drive within the automated valet parking lot by controlling vehicle actuator 17 according to driving data. Specifically, driving controller 18 controls vehicle actuator 17 such that vehicle 2 drives a driving route indicated by the driving data, while avoiding contact with obstacles and another vehicle 2a. Moreover, vehicle actuator 17 is at least one actuator for actuating or steering the wheels of vehicle 2. The at least one actuator is, for example, a motor, an engine, etc.

In addition, as one of the actions, control device 10 provides a notification of first malfunction information and/or second malfunction information to at least vehicle 2 (first vehicle), by obtaining information (human detection information) indicating the presence of a person in the cabin of the first vehicle from another vehicle 2a (second vehicle) different from the first vehicle. Specifically, when control device 10 obtains a first signal from first monitoring device 20, control device 10 can determine whether a person is present or not in the cabin of the first vehicle, by receiving human detection information from the second vehicle different from the first vehicle provided with the above-mentioned control device 10. In addition, when control device 10 obtains a second signal from second monitoring device 16, control device 10 can also determine whether a person is present or not in the cabin of the first vehicle, by receiving human detection information from the second vehicle different from the first vehicle provided with the above-mentioned control device 10.

Moreover, control device 10 determines the presence of a person in the cabin, by receiving human detection information from at least one of first monitoring device 20 and second monitoring device 16. In this case, control device 10 performs the following predetermined actions.

For example, when control device 10 receives an instruction to stop vehicle 2 from external device 3 via communication device 15, control device 10 stops vehicle 2 as a predetermined action, by controlling vehicle actuator 17 via driving controller 18. In addition, when control device 10 receives an instruction to make a detour from external device 3 via communication device 15, control device 10 causes vehicle 2 to make a detour as a predetermined action, by controlling vehicle actuator 17 via driving controller 18 such that vehicle 2 moves to an avoidance area. In this case, control device 10 causes vehicle 2 to move to the avoidance area, by receiving a driving route for the detour from external device 3 such that vehicle 2 can make the detour to the avoidance area. In addition, when control device receives human detection information, control device 10 provides a notification of the human detection information to external device 3 and controls in-vehicle device 11, as predetermined actions. For example, when control device 10 receives human detection information, control device 10 transmits an instruction to stop driving to external device 3 via communication device 15 as a predetermined action. Accordingly, when external device 3 receives the instruction to stop driving, external device 3 controls an arm barrier etc. provided in a driving route to stop vehicle 2 by lowering the arm barrier, as one mode of stopping vehicle 2 from driving. Moreover, as a predetermined action, control device 10 provides a notification, to a person present in the cabin, that the person should not be in the cabin via in-vehicle device 11. In addition, when control device 10 obtains human detection information from second monitoring device 16, control device 10 transmits the human detection information to external device 3 via communication device 15. With this, a manager of external device 3 can become aware of the presence of a person in the automated valet parking lot.

Accordingly, the manager can send a staff member to the location where the person is present.

### [Processing Operation]

Next, the processing operation performed by vehicle monitoring system 5 and a malfunction monitoring method according to the embodiment will be described.

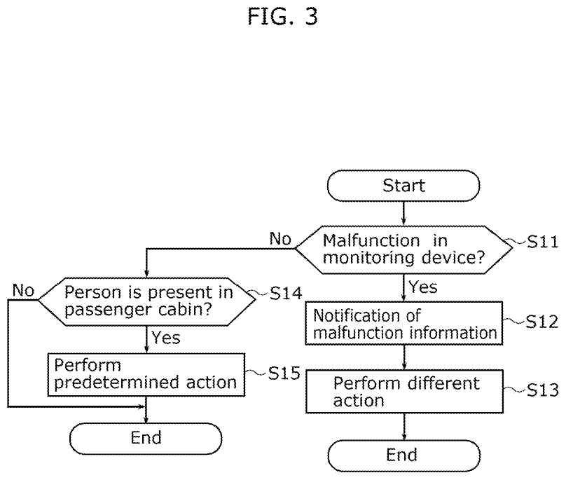

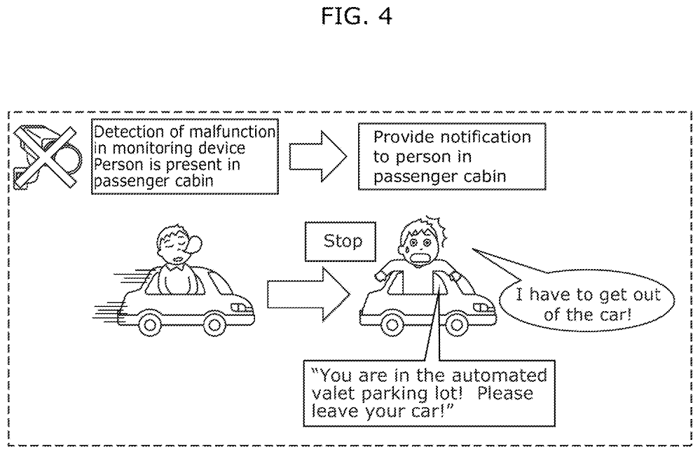

FIG. 3 is a flowchart illustrating operation performed by vehicle monitoring system 5 according to the embodiment. FIG. 4 is a diagram schematically illustrating an action performed by vehicle monitoring system 5, when a person is present in a parking lot.

### OPERATION EXAMPLE 1

As illustrated in FIG. 3, when first monitoring device 20 malfunctions, first monitoring device 20 transmits a first signal that is information indicating that first monitoring device 20 itself is experiencing a malfunction to control device 10 of vehicle 2. First monitoring device 20 transmits the first signal to control device 10 of every vehicle 2 present in an automated valet parking lot. Note that, unless otherwise stated, the operation example will be mainly described using one vehicle 2.

In contrast, when first monitoring device 20 is not experiencing a malfunction, first monitoring device 20 does not transmit the first signal to control device 10 of vehicle 2. Note that, when first monitoring device 20 is not experiencing a malfunction, first monitoring device 20 may transmit normality information indicating that first monitoring device 20 is not experiencing a malfunction and that first monitoring device 20 is in the normal state to control device 10 of vehicle 2.

Control device 10 determines whether first monitoring device 20 is experiencing a malfunction (S11).

When control device 10 determines that first monitoring device 20 is experiencing a malfunction by receiving a first signal from first monitoring device 20 (YES in S11), control device 10 provides a notification of first malfunction information via in-vehicle device 11 and terminal device 50 (S12). For example, control device 10 provides, via in-vehicle device 11 and terminal device 50, a notification indicating that first monitoring device 20 is experiencing a malfunction and that a person present in the cabin needs to get out of the vehicle for evacuation.

Next, after control device 10 has provided the notification of the first malfunction information, control device 10 causes vehicle 2 provided with control device 10, external device 3, terminal device 50, etc. to perform an action different from providing of the malfunction information notification (S13).

Control device 10 performs at least one action among the following actions different from providing of the malfunction information notification: the actuation of an acoustic device, the actuation of an in-vehicle lighting device, the actuation of a display device, the actuation of a seat device, providing of a notification to terminal device 50 provided in vehicle 2, etc. For example, control device 10 controls at least one of in-vehicle devices 11 present in vehicle 2, such as an acoustic device, an in-vehicle lighting device, a display device, and a seat device, to actuate the device such that a person is intuitively become aware of the notification. In addition, control device 10 can also transmit, via communication device 15, malfunction information to terminal device 50 provided in vehicle 2. Moreover, among the foregoing actions, control device 10 may change, for every predetermined period, an action to be performed. Moreover, control device 10 may simultaneously perform all of or several of the actions.

For example, vehicle monitoring system 5 can notify a person in a cabin as illustrated in FIG. 4 or a person in the vicinity of vehicle 2 that first monitoring device 20 is experiencing a malfunction, and that the person present in the cabin needs to get out of the vehicle for evacuation.

Alternatively, when control device 10 does not receive the first signal from first monitoring device 20 in step S11, or when control device 10 receives the normality information in step S11, control device 10 determines that first monitoring device 20 is not experiencing a malfunction (working normally) (NO in S11).

Next, control device 10 determines whether a person is present or not in the cabin (S14).

Control device 10 determines the presence of a person in the cabin, by receiving human detection information from at least one of first monitoring device 20 and second monitoring device 16 (YES in S14).

In this case, control device 10 performs a predetermined action (S15). The predetermined action includes, for example, the following actions.

As the predetermined actions, control device 10: stops vehicle 2, moves vehicle 2 to an avoidance area, transmits an instruction to stop driving in order to stop vehicle 2 (lowers an arm barrier), provides a notification that a person is not allowed to stay in the cabin, transmits human detection information transmitted from second monitoring device 16 (sends a staff member), etc. The notification that a person is not allowed to stay in the cabin is provided by, for example, voice, text, an image conveying a message saying “You are in the automated valet parking lot! Please leave your car!” as illustrated in FIG. 4, for example. Specifically, control device 10 actuates an acoustic device to output voice conveying the message saying “You are in the automated valet parking lot! Please leave your car!” If the acoustic device is a radio, the voice may be broadcast on the radio. Alternatively, control device 10 actuates a display device to output text or an image showing the message stating “You are in the automated valet parking lot! Please leave your car!” Such voice, text, an image, etc. may be output by control device 10 as information prestored in a storage and the like that vehicle monitoring system 5 is provided with. Alternatively, the manager of external device 3 may cause in-vehicle device 11 to output such voice, text, an image, etc.

For example, control device 10 performs at least one action among the several predetermined actions. Among the several predetermined actions, control device 10 may change, for every predetermined period, an action to be performed. Moreover, control device 10 may cause all of or several of the actions to be simultaneously performed.

For example, a person present in a cabin as illustrated in FIG. 4, or a person in the vicinity of vehicle 2 can become aware that they should not be in the cabin.

Thereafter, control device 10 ends the processing operation shown in the flowchart.

Alternatively, when control device 10 does not receive the human detection information, control device 10 determines that a person is not present in the cabin (NO in S14). Note that control device 10 also determines that a person is not present in the cabin, when control device 10 receives information indicating that no one is in the automated valet parking lot from both first monitoring device 20 and second monitoring device 16.

Thereafter, control device 10 ends the processing operation shown in the flowchart.

### OPERATION EXAMPLE 2

The operation example represents the case where second monitoring device 16 has malfunctioned. Processes that are the same as processes described in operation example 1 share the same reference signs, and description of those processes will be omitted.

As illustrated in FIG. 3, when second monitoring device 16 malfunctions, second monitoring device 16 transmits a second signal that is information indicating that second monitoring device 16 itself is experiencing a malfunction to control device 10 of vehicle 2. Second monitoring device 16 transmits the second signal to only vehicle 2 provided with the second monitoring device 16, or to control device 10 of every vehicle 2 provided with second monitoring device in an automated valet parking lot. Alternatively, second monitoring device 16 may transmit the second signal to external device 3 via communication device 15. Note that, unless otherwise stated, the operation example will be mainly described using one vehicle 2.

In contrast, when second monitoring device 16 is not experiencing a malfunction, second monitoring device 16 does not transmit the second signal to control device 10 of vehicle 2. Note that, when second monitoring device 16 is not experiencing a malfunction, second monitoring device 16 may transmit normality information indicating that second monitoring device 16 is not experiencing a malfunction and that second monitoring device 16 is in the normal state to control device 10 of vehicle 2.

Control device 10 determines whether second monitoring device 16 is experiencing a malfunction (S11).

When control device 10 determines that second monitoring device 16 is experiencing a malfunction by receiving a second signal from second monitoring device 16 (YES in S11), control device 10 provides a notification of second malfunction information via in-vehicle device 11 and terminal device 50 (S12). For example, control device 10 provides, via in-vehicle device 11 and terminal device 50, a notification that second monitoring device 16 is experiencing a malfunction and that a person present in the cabin needs to get out of the vehicle for evacuation.

Next, after control device 10 has provided the notification of the second malfunction information, control device 10 causes vehicle 2 provided with at least control device 10, external device 3, terminal device 50, etc. to perform an action different from providing of the malfunction information notification (S13).

With this, a notification that second monitoring device 16 is experiencing a malfunction and that a person present in the cabin needs to get out of the vehicle for evacuation is provided for at least the person present in the cabin.

Alternatively, when control device 10 does not receive the second signal from second monitoring device 16, or when control device 10 receives normality information from second monitoring device 16, control device 10 determines that second monitoring device 16 is not experiencing a malfunction (working normally) (NO in S11). Thereafter, control device 10 proceeds with steps S14 through S15, and ends the processing operation shown in the flowchart.

### Advantageous Effects

Next, advantageous effects produced by vehicle monitoring system 5 and the malfunction monitoring method according to the embodiment will be described.

In conventional monitoring systems, the case where those monitoring systems malfunction had not been considered. Accordingly, such conventional monitoring systems may not be able to properly detect a person when the monitoring systems malfunction. Even in the case where a monitoring system malfunctions, effective operation of an automated valet parking lot by securing safety of people in the automated valet parking lot and by minimizing occurrences of injuries in the automated valet parking lot is sought after.

As has been described above, vehicle monitoring system 5 according to the embodiment includes: a monitoring device that monitors whether a person is present or not in a cabin of vehicle 2 capable of autonomous driving; and control device 10 that determines whether the monitoring device is experiencing a malfunction, and outputs a result of the determination.

With this, even if a monitoring device is experiencing a malfunction, it is possible to notify others that the monitoring device is experiencing a malfunction, and also possible to notify a person in a cabin or in the vicinity of a vehicle that they need to get out of the vehicle for evacuation. Accordingly, taking an action, such as repairing or replacing the monitoring device, makes it possible to monitor the inside of an automated valet parking lot. For example, since a person in the automated valet parking lot can be detected, it is possible to reduce the risk of leaving the person behind in the automated valet parking lot. A reduction in the risk of leaving a person behind in an automated valet parking lot is unlikely to reduce the efficiency in operating the automated valet parking lot.

Therefore, vehicle monitoring system 5 can secure the safety of people in an automated valet parking lot, while effectively operating the automated valet parking system.

Particularly, since a notification that a person should not be in the automated valet parking lot can be provided to the person even if the person is in the automated valet parking lot, injuries resulting from, for example, an accident caused by the person running into a vehicle in the automated valet parking lot are unlikely to occur. Moreover, since vehicle monitoring system 5 prevents a person from staying in an automated valet parking lot, damages such as theft from vehicles and car robbery are unlikely to occur. As a result, occurrences of injuries and damages in an automated valet parking lot can be minimized.

In addition, a malfunction monitoring method according to the embodiment includes: monitoring, by a monitoring device, whether a person is present or not in a cabin of vehicle 2; determining whether the monitoring device monitoring is experiencing a malfunction; and outputting a result of the determination.

This malfunction monitoring method produces the same advantageous effects as described above.

Moreover, vehicle monitoring system 5 according to the embodiment includes at least one of: a monitoring device that is provided outside vehicle 2, and a monitoring device that vehicle 2 is provided with.

With this, since a monitoring device is provided at least outside vehicle 2, such as a management office of an automated valet parking lot, or at least vehicle 2 is provided with a monitoring device, it is possible to monitor the automated valet parking lot.

In addition, in vehicle monitoring system 5 according to the embodiment, the monitoring device includes at least one of: first monitoring device 20 that is provided outside vehicle 2, and monitors whether a person is present or not in the cabin of vehicle 2; and second monitoring device 16 that the vehicle is provided with, and monitors whether a person is present or not in the cabin of vehicle 2.

With this, first monitoring device 20 that monitors vehicle 2 from outside and second monitoring device 16 that monitors the cabin can accurately monitor whether a person is present or not in the cabin.

In addition, in vehicle monitoring system 5 according to the embodiment, when control device 10 determines that first monitoring device 20 is experiencing a malfunction, control device 10 provides, to vehicle 2, a notification of first malfunction information that is information about the malfunction in first monitoring device 20 as a result of the determination.

With this, a malfunction in first monitoring device 20 can be notified to a person in, for example, the cabin. Accordingly, the person in, for example, the cabin becomes aware that they are in a situation where their safety is threatened, and thus becomes aware that they should not be in the cabin.

Moreover, since an action, such as repairing or replacing first monitoring device 20, can be taken, it is possible to monitor the entire automated valet parking lot from outside vehicle 2. This reduces the risk of leaving people behind in the automated valet parking lot, thereby reducing a decrease in efficiency of operating the automated valet parking lot.

In addition, in vehicle monitoring system 5 according to the embodiment, when control device 10 determines that second monitoring device 16 is experiencing a malfunction, control device 10 provides, to at least vehicle 2 that is provided with second monitoring device 16 experiencing the malfunction, a notification of second malfunction information that is information about the malfunction in second monitoring device 16 as a result of the determination.

With this, a malfunction in second monitoring device 16 can be notified to a person in, for example, the cabin. Accordingly, the person in, for example, the cabin becomes aware that they are in a situation where their safety is threatened, and thus becomes aware that they should not be in the cabin. Moreover, when the person in the cabin is provided with a notification that that they need to get out of the vehicle for evacuation, the person would immediately get out of the vehicle and would take an action for evacuation.

Moreover, since an action, such as repairing or replacing second monitoring device 16, can be taken, it is possible to monitor at least the cabin. This reduces risks of leaving people behind in the cabin, thereby reducing a decrease in efficiency of operating the automated valet parking system.

In addition, in vehicle monitoring system 5 according to the embodiment, control device 10 performs an action different from providing of the notification of the first malfunction information, after control device 10 has provided the notification of the first malfunction information.

Accordingly, some action performed by vehicle 2 causes a person in, for example, the cabin to feel anxious for an unusual situation. Accordingly, the person in, for example, the cabin becomes aware that they are in a situation where their safety is threatened, and thus becomes aware that they should not be in the cabin. For this reason, the person takes an action to evacuate from vehicle 2.

In addition, vehicle monitoring system 5 according to the embodiment, control device 10 performs an action different from providing of the notification of the second malfunction information, after control device 10 has provided the notification of the second malfunction information.

Accordingly, a certain action performed by vehicle 2 causes a person in, for example, the cabin to feel anxious for an unusual situation. Accordingly, the person in, for example, the cabin becomes aware that they are in a situation where their safety is threatened, and thus becomes aware that they should not be in the cabin. For this reason, the person takes an action to evacuate from vehicle 2.

In addition, in vehicle monitoring system 5 according to the embodiment, as the action, control device 10 actuates devices present in vehicle 2.

Accordingly, the actuation of devices present in vehicle 2 causes a person in the cabin to feel anxious. Accordingly, the person in, for example, the cabin becomes aware that they are in a situation where their safety is threatened, and thus becomes aware that they should not be in the cabin.

In addition, in vehicle monitoring system 5 according to the embodiment, as the action, control device 10 provides a notification of information (included in malfunction information) indicating the malfunction in the monitoring device to external device 3.

With this, since information indicating a malfunction in a monitoring device can be transmitted to external device 3, it is possible to notify the malfunction in the monitoring device to a manager of external device 3. Accordingly, an action, such as repairing or replacing the monitoring device, can be taken, and the safety of the automated valet parking lot can be secured. Therefore, it is possible to further reduce a decrease in efficiency of operating an automated valet parking system.

In addition, in vehicle monitoring system 5 according to the embodiment, as the action, control device 10 controls vehicle 2 to stop driving or to move to a predetermined location.

With this, it is possible to guide a person in, for example, a cabin for evacuation. Therefore, the safety of an automated valet parking lot can be further secured.

In addition, in vehicle monitoring system 5 according to the embodiment, as the action, control device 10 provides a notification of malfunction information (first malfunction information and/or second malfunction information) that is information about a malfunction in the monitoring device (first monitoring device 20 and second monitoring device 16) to vehicle 2 by obtaining information indicating presence of a person in the cabin of vehicle 2 from another vehicle 2a different from vehicle 2.

With this, even if a monitoring device malfunctions, the use of a monitoring device of another vehicle 2a makes it possible to detect the presence of a person in the cabin of vehicle 2. Therefore, the safety of an automated valet parking lot can be further secured.

### [Other Variations]

Hereinbefore, the vehicle monitoring system and the malfunction monitoring method according to the present disclosure have been described based on the above embodiments, but the present disclosure is not limited to these embodiments. Embodiments arrived at by a person of skill in the art making various modifications to the embodiments which do not depart from the essence of the present disclosure may be included in the present disclosure.

For example, each of elements included in the vehicle monitoring system and the malfunction monitoring method according to the above embodiments are typically implemented as LSI that is an integrated circuit. These elements may be individually implemented as a single chip, or some or all of the elements may be implemented as a single chip.

Circuit integration is not limited to LSI; the elements may be implemented as a dedicated circuit or generic processor. A field programmable gate array (FPGA) that is programmable after manufacturing of the LSI circuit, or a reconfigurable processor whose circuit cell connections and settings in the LSI circuit are reconfigurable, may be used.

Note that, in the above embodiments, the elements may be configured as dedicated hardware or may be implemented by executing a software program suitable for the element. Each element may be implemented as a result of a program execution unit, such as a CPU or processor or the like, loading and executing a software program stored in a storage medium such as a hard disk or semiconductor memory.

Numbers used above are used as examples for specifically describing the present disclosure, therefore the embodiments according to the present disclosure are not limited to the numbers.

The block diagrams illustrate one example of the division of functional blocks, but a plurality of functional blocks may be realized as a single functional block, a single functional block may be broken up into a plurality of functional blocks, and part of one function may be transferred to another functional block. Moreover, the functions of a plurality of function blocks having similar functions may be processed by a single piece of hardware or software in parallel or by time-division.

The order in which the steps are executed in the flowcharts are mere examples for presenting specific examples of the present disclosure; the orders are not limited to the illustrated orders. Moreover, some of the steps may be executed at the same time as (in parallel with) other steps.

The present disclosure also encompasses: embodiments achieved by applying various modifications conceivable to those skilled in the art to each embodiment; and embodiments achieved by optionally combining the structural elements and the functions of each embodiment without departing from the essence of the present disclosure.

While various embodiments have been described herein above, it is to be appreciated that various changes in form and detail may be made without departing from the spirit and scope of the present disclosure as presently or hereafter claimed.

Further Information about Technical Background to this Application

The present application is based on and claims priority of Japanese Patent Application No. 2021-073897 filed on Apr. 26, 2021.

### Industrial Applicability

The present disclosure is applicable to devices and systems that manage driving of vehicles in, for example, automated valet parking lots.

1. A vehicle monitoring system comprising:
a monitoring device that monitors whether a person is present or not in a cabin of a vehicle capable of autonomous driving; and
a control device that determines whether the monitoring device is experiencing a malfunction, and outputs a result of the determination.

2. The vehicle monitoring system according to claim 1, wherein
the monitoring device includes at least one of:
a first monitoring device that is provided outside the vehicle, and monitors whether a person is present or not in the cabin of the vehicle; or
a second monitoring device that the vehicle is provided with, and monitors whether a person is present or not in the cabin of the vehicle.

3. The vehicle monitoring system according to claim 2, wherein
when the control device determines that the first monitoring device is experiencing a malfunction, the control device provides, to the vehicle, a notification of first malfunction information that is information about the malfunction in the first monitoring device as a result of the determination.

4. The vehicle monitoring system according to claim 2, wherein
when the control device determines that the second monitoring device is experiencing a malfunction, the control device provides, to at least the vehicle that is provided with the second monitoring device experiencing the malfunction, a notification of second malfunction information that is information about the malfunction in the second monitoring device as a result of the determination.

5. The vehicle monitoring system according to claim 3, wherein
after the control device has provided the notification of the first malfunction information, the control device performs an action different from providing of the notification of the first malfunction information.

6. The vehicle monitoring system according to claim 4, wherein
after the control device has provided the notification of the second malfunction information, the control device performs an action different from providing of the notification of the second malfunction information.

7. The vehicle monitoring system according to claim 5, wherein
as the action, the control device actuates a device present in the vehicle.

8. The vehicle monitoring system according to claim 5, wherein
as the action, the control device provides a notification of information indicating the malfunction in the monitoring device to an external device.

9. The vehicle monitoring system according to claim 5, wherein
as the action, the control device controls the vehicle to stop driving or to move to a predetermined location.

10. The vehicle monitoring system according to claim 5, wherein
as the action, the control device provides a notification of malfunction information that is information about a malfunction in the monitoring device to the vehicle by obtaining information indicating presence of a person in the cabin of the vehicle from another vehicle different from the vehicle.

11. A malfunction monitoring method comprising:
monitoring, by a monitoring device, whether a person is present or not in a cabin of a vehicle;
determining whether the monitoring device monitoring is experiencing a malfunction; and
outputting a result of the determination.
